(19) United States
(12) Patent Application Publication
(10) Pub. No.: US 2013/0067444 A1
(43) Pub. Date: Mar. 14, 2013

(54) RECONFIGURABLE PROCESSOR, AND APPARATUS AND METHOD FOR CONVERTING CODE THEREOF

(71) Applicant: Tai-Song JIN, Seoul (KR)

(72) Inventor: Tai-Song JIN, Seoul (KR)

(73) Assignee: SAMSUNG ELECTRONICS CO., LTD., Suwon-si (KR)

(21) Appl. No.: 13/606,671

(22) Filed: Sep. 7, 2012

(30) Foreign Application Priority Data
Sep. 9, 2011 (KR) 10-2011-0092114

(51) Int. Cl. G06F 9/45

(52) U.S. Cl. 717/151

(57) ABSTRACT

An apparatus and method are provided to minimize an overhead caused by mode conversion by processing parts that cannot be subject to software pipelining. A processor is configured to execute code including a first part that is able to be subject to software pipelining in the code, and a second part that is disable to be subject to software pipelining in the code, the second part including a data part and a control part. The processor is further configured to execute the first part, and the data part of the second part in a first execution mode, and to execute the control part of the second part in a second execution mode. When the first part and the data part, the data part and the first part, or different data parts are successively executed, the processor processes the code in the first execution mode without entering the second execution mode.

### CROSS-REFERENCE TO RELATED APPLICATION

This application claims the benefit under 35 U.S.C. §119(a) of Korean Patent Application No. 10-2011-0092114, filed on Sep. 9, 2011, in the Korean Intellectual Property Office, the entire disclosure of which is incorporated herein by reference for all purposes.

### BACKGROUND

1. Field

The following description relates to a reconfigurable processor and a compiler thereof.

2. Description of the Related Art

Reconfigurable architecture refers to architecture capable of changing a hardware configuration of a computing device according to a task to be executed in order to provide an optimized hardware configuration for performing the task.

Processing a certain task using hardware may have lower efficiency compared to software, especially when the task is modified or changed since the functions of hardware are fixed. On the other hand, processing a certain task using software may result in lower processing speed compared to hardware-implemented processing, although software can be readily changed to be suitable for the task. The reconfigurable architecture has many advantages of both hardware and software. For instance, the reconfigurable architecture can be efficiently applied to digital signal processing including the iterative execution of the same task.

One type of reconfigurable architecture is a Coarse-Grained Array (CGA). The CGA is composed of a plurality of processing units, and can be optimized for a specific task by changing the connection states between the processing units.

Meanwhile, a Very Long Instruction Word (VLIW) machine has been introduced that is a reconfigurable architecture that utilizes specific processing units of a CGA. This reconfigurable architecture has two execution modes: a CGA mode and a VLIW mode. Conventionally, the VLIW machine reconfigurable architecture processes loop operations where the same operation is iteratively executed in the CGA mode, and processes normal operation other than loop operations) in the VLIW mode.

### SUMMARY

According to one general aspect, a reconfigurable processor may include a processor configured to execute code including a first part that is able to be subject to software pipelining in the code, and a second part that is disable to be subject to software pipelining in the code, the second part including a data part and a control part, wherein the processor is configured: (i) to execute the first part, and the data part of the second part in a first execution mode, and (ii) to execute the control part of the second part in a second execution mode, and when the first part and the data part, the data part and the first part, or different data parts are successively executed, the processor processes the code in the first execution mode without entering the second execution mode.

The first execution mode may be based on a Coarse-Grained Array (CGA) architecture, and the second execution mode may be based on Very a Long Instruction Word (VLIW) architecture.

According to another general aspect, a code conversion apparatus of a reconfigurable processor may include: a classifying unit configured to classify a code into a first part that is able to be subject to software pipelining, and a second part that is disable to be subject to software pipelining, and to classify the second part into a data part and a control part; a mapping unit configured to map the first part and the data part of the second part to a first execution mode of the reconfigurable processor, and the control part of the second part to a second execution mode of the reconfigurable processor; and a mode conversion controller configured to insert, when the first part and the data part, the data part and the first part, or different data parts are successively executed, an additional instruction instructing continuous execution of the first execution mode without entering the second execution mode, into the code.

The first execution mode may be based on a Coarse-Grained Array (CGA) architecture, and the second execution mode may be based on a Very Long Instruction Word (VLIW) architecture.

The mode conversion controller may insert an instruction for prohibiting conversion of an execution mode between a point at which the data part ends in the code and a point at which the first part starts in the code, or between a point at which the first part ends in the code and a point at which the data part starts in the code, until a predetermined condition is satisfied.

The predetermined condition may include a return instruction instructing returning to the second execution mode.

The mode conversion controller may insert a predetermined divergence instruction when different data parts are successively executed.

The classifying unit may classify the second part into the data part and the control part according to a schedule length.

The mapping unit may insert a predetermined CGA call instruction at a point at which the data part starts in the code.

According to yet another general aspect, a code conversion apparatus for a reconfigurable processor may include: a classifying unit configured to classify a code into a SP part defined as a part that is able to be subject to software pipelining, a D part defined as a data part that is disable to be subject to software pipelining, and a C part defined as a control part that is disable to be subject to software pipelining; a mapping unit configured to map the SP part and the D part to a Coarse-Grained Array (CGA) mode, and the C part to a Very Long Instruction Word (VLIW) mode; and a mode conversion controller configured to insert, when the SP part and the D part, the D part and the SP part, or different D parts are successively executed, at least one additional instruction instructing continuous execution of the CGA mode without entering the VLIW mode, into the code.

The additional instruction may include a mode conversion prohibition instruction instructing continuous execution of the CGA mode until a VLIW return instruction is executed.

The additional instruction may include a divergence instruction that is inserted before an execution location of the VLIW return instruction.

According to a further general aspect, a code conversion method for a reconfigurable processor may include: classifying a code into a SP part defined as a part that is able to be subject to software pipelining, a D part defined as a data part that is disable to be subject to software pipelining, and a C part defined as a control part that is disable to be subject to software pipelining; mapping the SP part and the D part to a Coarse-Grained Array (CGA) mode, and the C part to a Very Long Instruction Word (VLIW) mode; and inserting, when the SP part and the D part, the D part and the SP part, or different D parts are successively executed, an additional instruction instructing continuous execution of the CGA mode without entering the VLIW mode, into the code.

The additional instruction may include a mode conversion prohibition instruction instructing continuous execution of the CGA mode until a VLIW return instruction is executed.

The additional instruction may include a divergence instruction that is inserted before an execution location of the VLIW return instruction.

According to still another general aspect, a code conversion method of a reconfigurable processor may include: classifying a code into a first part that is able to be subject to software pipelining, and a second part that is disable to be subject to software pipelining, and to classify the second part into a data part and a control part; mapping the first part and the data part of the second part to a first execution mode of the reconfigurable processor, and the control part of the second part to a second execution mode of the reconfigurable processor; and inserting, when the first part and the data part, the data part and the first part, or different data parts are successively executed, an additional instruction instructing continuous execution of the first execution mode without entering the second execution mode, into the code.

The first execution mode may be based on a Coarse-Grained Array (CGA) architecture, and the second execution mode is based on a Very Long Instruction Word (VLIW) architecture.

The inserting may include inserting an instruction for prohibiting conversion of an execution mode between a point at which the data part ends in the code and a point at which the first part starts in the code, or between a point at which the first part ends in the code and a point at which the data part starts in the code, until a predetermined condition is satisfied.

The predetermined condition may include a return instruction instructing returning to the second execution mode.

The inserting may include inserting a predetermined divergence instruction when different data parts are successively executed.

The classifying may include classifying the second part into the data part and the control part according to a schedule length.

The mapping may include inserting a predetermined CGA call instruction at a point at which the data part starts in the code.

Other features and aspects will be apparent from the following detailed description, the drawings, and the claims.

### BRIEF DESCRIPTION OF THE DRAWINGS

FIG. 1 is a diagram illustrating a reconfigurable processor.

FIG. 2 is a diagram illustrating a code conversion apparatus.

FIG. 3 shows a code block tree where code blocks are arranged in a processing order.

FIG. 4 is a view for comparing an example where no additional instruction is used with an example where additional instructions are used.

FIG. 5 is a view for comparing the example where no additional instruction is used with another example where additional instructions are used.

FIG. 6 is a flowchart illustrating a code conversion method.

FIG. 7 is a flowchart illustrating a code classifying and mapping method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

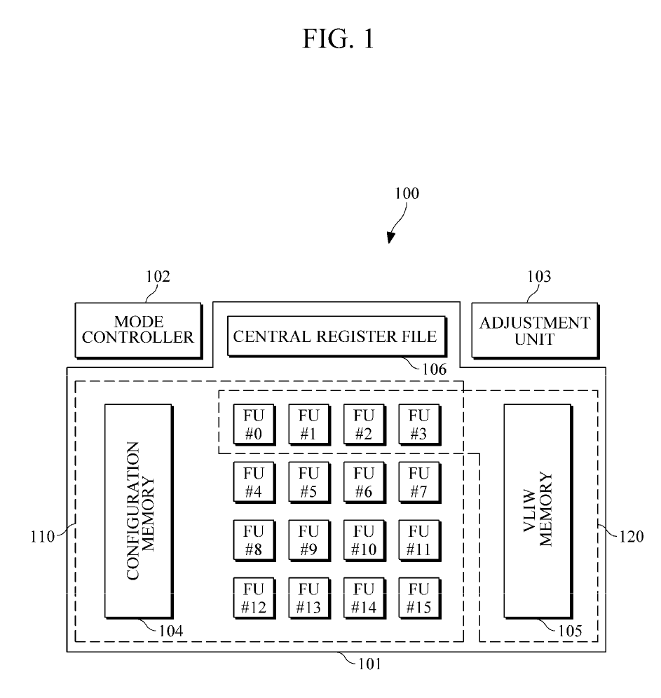

FIG. 1 is a diagram illustrating a reconfigurable processor 100.

Referring to FIG. 1, the reconfigurable processor 100 includes a processor 101, a mode controller 102, and an adjustment unit 103.

The processor 101 includes a plurality of functional units FU#0 through FU#15. The individual functional units FU#0 through FU#15 may be configured to process tasks or instructions independently. For example, while the functional unit FU#1 processes a first instruction, the functional unit FU#2 may process another instruction which is independent from the first instruction. One or more of the functional units FU#0 through FU#15 may include a processing element (PE) for performing arithmetic/logic operation, and a register file (RF) for temporarily storing the results of processing by the processing element PE.

The processor 101 has at least two execution modes: one is a Coarse-Grained Array (CGA) mode and the other is a Very Long Instruction Word (VLIW) mode. However, it will be appreciated that the execution modes are not limited to the CGA and VLIW modes; other modes may be possible in some implementations.

In the CGA mode, the processor 101 may operate based on a CGA machine 110. For example, the processor 101 may process CGA instructions based on the functional units FU#0 through FU#15. The CGA instruction may include a loop operation. Also, the CGA instruction may include configuration information that defines a connection relationship of the functional units FU#0 through FU#15. The CGA instruction may be loaded from a configuration memory 104. In the VLIW mode, the processor 101 may operate based on the VLIW machine 120. For example, the processor 101 may process VLIW instructions based on a part (for example, FU#0 through FU#3) of the functional units FU#0 through FU#15. The VLIW instruction may include normal operation other than a loop operation. The VLIW instruction may be loaded from a VLIW memory 105.

In one or more embodiments, the configuration memory 104, the VLIW memory 105, or both, may be at least one recording medium from among a flash memory type, a hard disk type, a multimedia card micro type, a card type memory (for example, a SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like. With this configuration, the processor 101 may perform normal operations in the VLIW mode and loop operations in the CGA mode. When a loop operation is performed in the CGA mode, a connection relationship between the functional units FU#0 through FU#15 may be optimized for the loop operation according to the configuration information stored in the configuration memory 104.

The mode controller 102 may control mode conversion of the processor 101. For example, the mode controller 102 may convert the processor 101 to the VLIW mode to the CGA mode, or the CGA mode to the VLIW mode, according to a predetermined instruction included in a code that is to be executed by the processor 101.

A central register file 106 may store context information upon mode conversion. For example, “Live-in data” or “Live-out data” according to mode conversion may be temporarily stored in the central register file 106.

The adjustment unit 103 may analyze the code that is to be executed by the processor 101 to decide which execution mode each part of the code has to be processed in. Also, the adjustment unit 103 may be configured to insert a predetermined instruction into the code in order to minimize conversion between execution modes. For example, the adjustment unit 103 may be a code conversion apparatus or a compiler.

According to various implementations, the processor 101 may be configured to execute a first part that can be subject to software pipelining in a code that is to be executed, and a data part of a second part that cannot be subject to software pipelining in the code, in a first execution mode (for example, in the CGA mode), and execute a control part of the second part in a second execution mode (for example in the VLIW mode). Also, when the first part and the data part, the data part and the first part, or different data parts are successively executed, the processor 101 may execute the corresponding code in the first execution mode without entering the second execution mode. The above-described process by the processor 101 may be implemented when the adjustment unit 103 analyzes a code that is to be executed and inserts a predetermined additional instruction upon compiling or during a run-time.

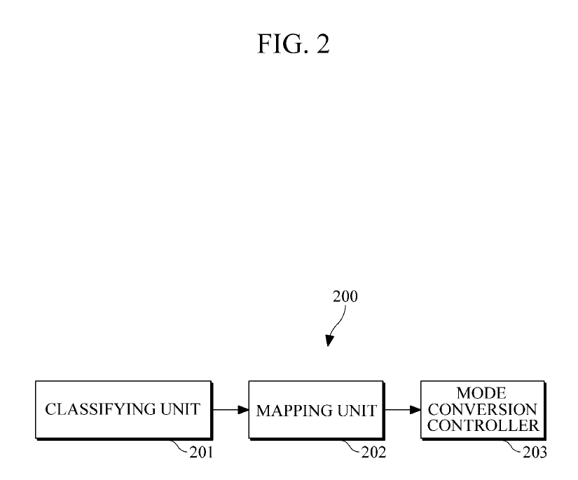

FIG. 2 is a diagram illustrating a code conversion apparatus 200 of the reconfigurable processor 100. The code conversion apparatus 200 may be the adjustment unit 103 illustrated in FIG. 1 in some embodiments.

Referring to FIG. 2, the code conversion apparatus 200 includes a classifying unit 201, a mapping unit 202, and a mode conversion controller 203.

The classifying unit 201 classifies a code that is to be executed into a first part and a second part. The first part is a part that can be subject to software pipelining, and the second part is a part that cannot be subject to software pipelining. For example, the classifying unit 201 may classify a loop area of a code into the first part and the remaining area into the second part.

Also, the classifying unit 201 may classify the second part into a data part and a control part. For example, the classifying unit 201 may classify the second part into a data part and a control part according to a predetermined schedule length. The data part may have relatively high data parallelism, and the schedule length may be an estimated execution time in a specific execution mode. For example, the classifying unit 201 may estimate an execution time (that is, a CGA schedule length) of a second part in the CGA mode and an execution time (that is, a VLIW schedule length) of the second part in the VLIW mode, respectively, and compare the estimated execution time in the CGA mode with the estimated execution time in the VLIW mode, thus determining whether to classify the corresponding second part into a data part or a control part. If the estimated execution time (that is, a CGA schedule length) of the second part in the CGA mode is shorter than its estimated execution time (that is, a VLIW schedule length) in the VLIW mode, the classifying unit 201 classifies the second part into a data part, and if the CGA schedule length of the second part is longer than its VLIW schedule length, the classifying unit 201 classifies the second part into a control part.

The mapping unit 202 maps the first part and the data part of the second part to the first execution mode (for example, the CGA mode) of the processor 101 (see FIG. 1), and maps the control part of the second part into the second execution mode (for example, the VLIW mode) of the processor 101. For example, the mapping unit 202 may insert predetermined call instructions so that the first execution mode is called at start points of a first part and a data part while a control part is executed in the second execution mode, thereby mapping each part to an appropriate execution mode.

When a first part and a data part, a data part and a first part, or different data parts are successively executed, the mode conversion controller 203 inserts additional instructions into the corresponding code so that the code is processed in the first execution mode without entering the second execution mode.

According to a non-limiting example, when a first part and a data part or a data part and a first part are successively executed, the mode conversion controller 203 may insert a mode conversion prohibition instruction for prohibiting mode conversion until a condition set between the first part and the data part (that is, between a point at which the data part ends in the corresponding code and a point at which the first part starts in the code, or between a point at which the first part ends in the corresponding code and a point at which the data part starts in the code) is satisfied.

When different data parts are successively executed like an iterative loop, the mode conversion controller 203 may insert, when execution of a data part is complete, a divergence instruction indicating changing of an execution location to another data part.

In addition, the mode conversion controller 203 may insert a divergence instruction instructing returning to the second execution mode, at a point at which the successive execution of a first part and a data part, a data part and a first part, or different data parts is complete.

For ease of understanding, the first part may be referred to as a “SP part”, the data part of the second part may be referred to as a “D part”, and the control part of the second part may be referred to as a “C part”. The SP part may be defined as a part that can be subject to software pipelining in the code. The D part may be defined as a part that cannot be subject to software pipelining in the code, but that can be executed in the CGA mode according to a schedule length. The C part may be defined as the remaining part excluding the SP part and the D part from the code.

The mapping unit 202 may map the SP part and the D part to the first execution mode, and the C part to the second execution mode. In the following description, the first execution mode to which the SP part is mapped is referred to as a “CGA sp mode”, the first execution mode to which the D part is mapped is referred to as a “CGA non-sp mode”, and the second execution mode to which the C part is mapped is referred to as a “VLIW mode”. In order to map a D part to the CGA mode (for example, the CGA non-sp mode), a method of inserting a CGA mode call instruction at a start point of the D part and a VLIW return instruction at an end point of the D part may be utilized. With the mode conversion controller 203, unnecessary conversion to the VLIW mode may occur when a D part and a SP part are successively executed. Accordingly, the mode conversion controller 203 may insert, after an execution mode for each part of a code is decided, the above-described instructions in order to minimize mode conversion.

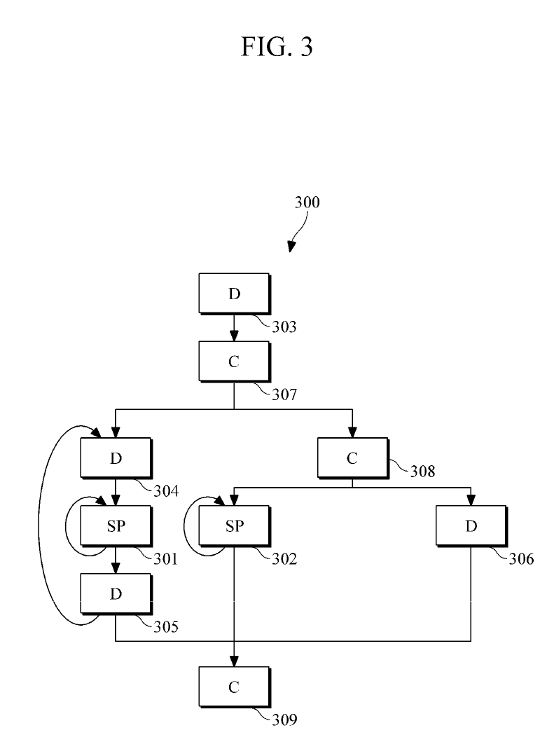

FIG. 3 shows a code block tree 300 where code blocks are arranged in a processing order.

Referring to FIG. 3, the code blocks are classified into SP blocks 301 and 302 that can be subject to software pipelining, and non-SP blocks 303 through 309 that cannot be subject to software pipelining, by the classifying unit 201. For example, the SP blocks 301 and 302 may correspond to a loop area in the corresponding code. Also, the non-SP blocks 303 through 309 may be classified into D blocks 303 through 306 and C blocks 307 through 309, according to predetermined schedule lengths, by the classifying unit 201.

The mapping unit 202 maps the SP blocks 301 and 302 and the D blocks 303 through 306 to the CGA mode, and the C blocks 307 through 309 to the VLIW mode. In general, the code blocks are processed basically in the VLIW mode by the classifying unit 201 and the mapping unit 202, and parts of the code blocks, which can be subject to software pipelining or which can be processed more efficiently in the CGA mode although they cannot be subject to software pipelining, are processed in the CGA mode. In order to minimize unnecessary conversion from the VLIW mode to the CGA mode or from the CGA mode to the VLIW mode, the mode conversion controller 203 may insert additional instructions.

For example, the mode conversion controller 203 may insert a “sp_call” instruction into an area where a SP block and a D block are successively executed, for example, between the blocks 301 and 305, or into an area where a D block and a SP block are successively executed, for example, between the blocks 304 and 301. The “sp_call” instruction may be an instruction for continuous execution of the CGA mode until a predetermined condition is satisfied. For example, if the mode conversion controller 203 may insert a “sp_call” instruction between the blocks 304 and 301, the blocks 304 and 301 are successively executed in the CGA mode without entering the VLIW mode.

In addition, the mode conversion controller 203 may insert a “branch” instruction into an area where different D blocks are successively executed, for example, between the blocks 305 and 304. The “branch” instruction may be an instruction for changing of an execution location (for example, a program counter) to a location which the corresponding instruction indicates until a predetermined condition is satisfied. For example, if the mode conversion controller 203 inserts the “branch” instruction after the block 305, the block 305 and the block 304 can be successively executed in the CGA mode without entering the VLIW mode.

The mode conversion controller 203 may insert a “return VLIW” instruction at a point (for example, at the block 305) at which the successive execution of a SP block and a D block is complete. For example, if the mode conversion controller 203 inserts a “return VLIW” instruction after the “branch” instruction in the example described above, the CGA mode may be released and the block 309 may be executed in the VLIW mode.

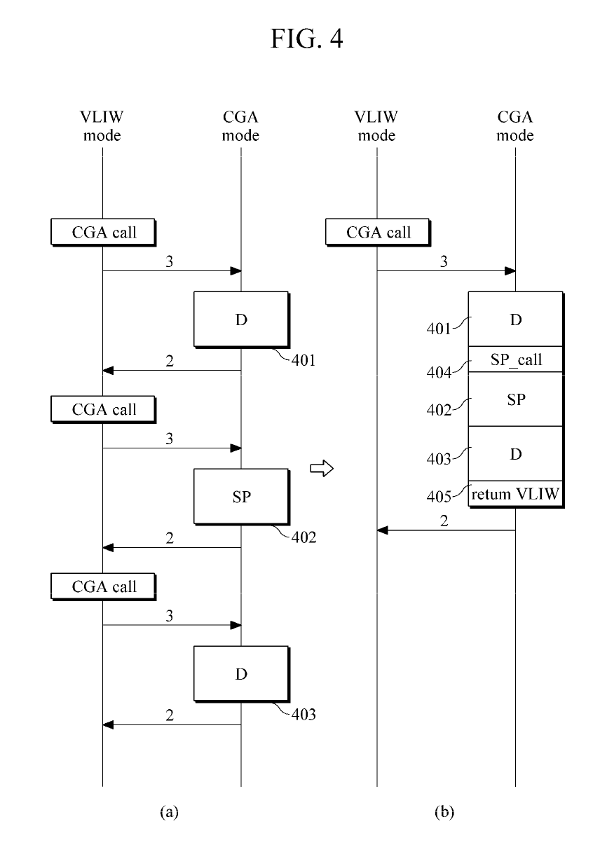

FIG. 4 is a view for comparing an example (a) where no additional instruction is used with an example (b) where additional instructions are used.

In the example (a), a D block #1 401, a SP block 402, and a D block #2 403 are successively executed, and whenever each block is executed, conversion between the CGA mode and the VLIW mode occurs.

In the example (b), like the example (a), the D block #1 401, the SP block 402, and the D block #2 403 are successively executed. However, the mode conversion controller (203 of FIG. 2) inserts a sp_call instruction 404 between the D block#1 401 and the SP block 402, and inserts a return VLIW instruction 405 after the D block#2 403. The sp_call instruction 404 may be an instruction that instructs the continuous execution of the CGA mode without entering the VLIW mode until the return VLIW instruction 405 is generated. The return VLIW instruction 405 may be an instruction instructing returning to the VLIW mode. In the example (b) where additional instructions are used, the D block#1 401, the SP block 402, and the D block#2 403 may be successively executed in the CGA mode.

For ease of understanding, it is assumed that conversion from the VLIW mode to the CGA mode has an overhead of 3 cycles, conversion from the CGA mode to the VLIW mode has an overhead of 2 cycles, and execution of an instruction has an overhead of 1 cycle. In this non-limiting case, the example (a) has an overhead of 15 cycles, while the example (b) has an overhead of 7 cycles.

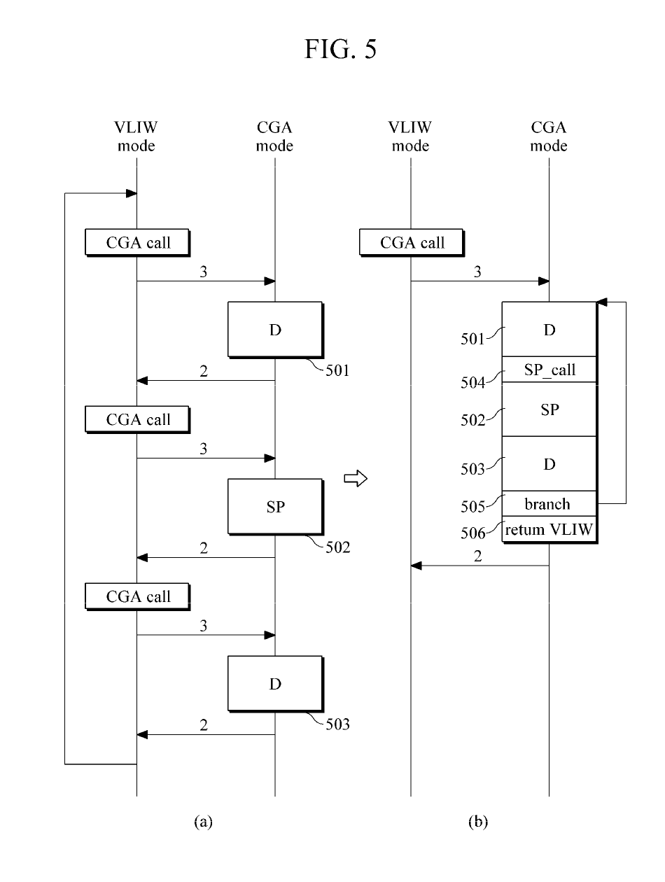

FIG. 5 is a view for comparing the example (a) where no additional instruction is used with another example (b) where additional instructions are used.

In the example (a), a D block#1 501, a SP block 502, a D block#2 503, and a D block#1 501 are successively and iteratively executed, and whenever each block is executed, conversion between the CGA mode and the VLIW mode occurs.

In the example (b), like the example (a), the D block #1 501, the SP block 502, the D block #2 503, and the D block#1 501 are successively executed. However, the mode conversion controller 203 (see FIG. 2) inserts a sp_call instruction 504 between the D block#1 501 and the SP block 502, and inserts a branch instruction 505 and a return VLIW instruction 506 after the D block#2 503. As described above, the sp_call instruction 504 may be an instruction instructing the continuous execution of the CGA mode without entering the VLIW mode until the return VLIW instruction 506 is generated, and the return VLIW instruction 506 may be an instruction instructing returning to the VLIW mode. Also, the branch instruction 505 may be an instruction instructing changing of an execution location until a predetermined condition is satisfied (for example, until execution of a loop is complete). Accordingly, in the example (b) where additional instructions are used, the D block#1 501, the SP block 502, the D block#2 503, and the D block#1 501 may be successively executed in the CGA mode.

For ease of understanding, it is assumed that conversion from the VLIW mode to the CGA mode has an overhead of 3 cycles, conversion from the CGA mode to the VLIW mode has an overhead of 2 cycles, execution of an instruction has an overhead of 1 cycle, changing an execution location has an overhead of 1 cycle, and the number of iterations is n.

In this non-limiting case, the example (a) has an overhead of 16*n cycles, while the example (b) has an overhead of (2*n+6) cycles.

It should be appreciated that the insertion locations and number of additional instructions are not limited to the examples (a) and (b) of FIGS. 4 and 5. For example, the sp_call instruction 504 may be inserted before the D block#1 501 or between the SP block 502 and the D block#2 503.

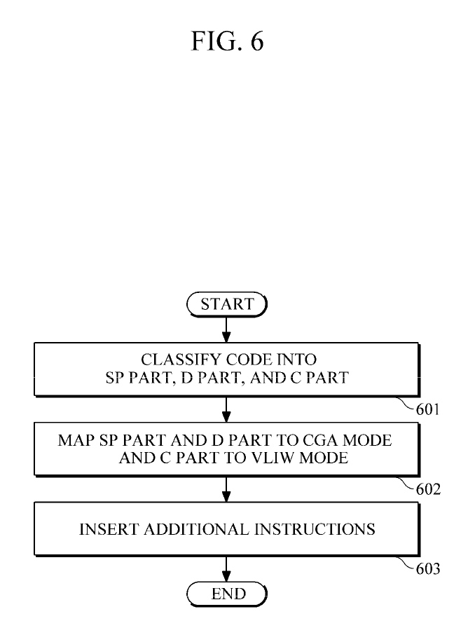

FIG. 6 is a flowchart illustrating a code conversion method.

In operation 601, the classifying unit 201 classifies a code that is to be executed into a SP part, a D part, and a C part. The SP part can be subject to software pipelining in the code, whereas the D part cannot be subject to software pipelining in the code, but that can be executed in the CGA mode according to a schedule length. The C part is the remaining part of the code excluding the SP part and the D part from the code. For example, referring to FIG. 3, the SP part may correspond to the SP blocks (i.e., 301 through 302), the D part may correspond to the D blocks (i.e., 303 through 306), and the C part may correspond to the C blocks (i.e., 308 and 309).

In operation 602, the mapping unit 202 maps the individual SP, D, and C parts to the CGA mode or the VLIW mode, selectively. For example, the mapping unit 202 may map the SP part and the D part to the CGA mode, and the C part to the VLIW mode.

According to a non-limiting example, the CGA mode to which the SP part is mapped may be referred to as a CGA sp mode, and the CGA mode to which the D part is mapped may be referred to as a CGA non-sp mode. The difference between the CGA sp mode and the CGA non-sp mode is in a program counter. In the CGA sp mode, the program counter shows iterations of sequentially increasing numbers, such as 1, 2, 3, 1, 2, 3, 1, . . . , while in the CGA non-sp mode, the program counter shows only sequentially increasing numbers, such as 1, 2, 3, . . . .

In operation 603, after the execution mode of each part is decided by the mapping unit 202, the mode conversion controller 203 inserts additional instructions so that mode conversion is minimized. For example, the mode conversion controller 203 may insert the “sp_call” instruction, the “branch” instruction, the “return VLIW” instruction, etc. into the code, as illustrated in FIGS. 4 and 5.

Accordingly, when the converted code is executed in the reconfigurable processor 100, the additional instructions function to prevent unnecessary mode conversion.

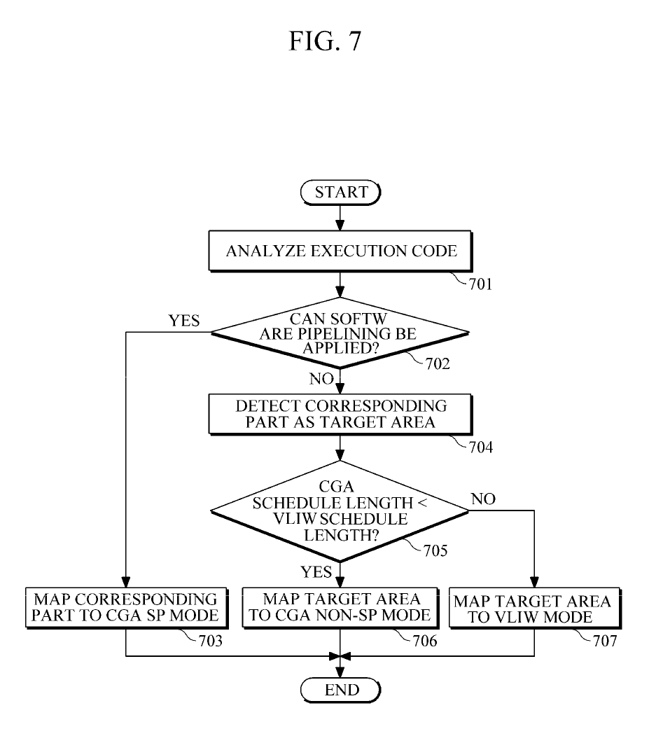

FIG. 7 is a flowchart illustrating a code classifying and mapping method.

Referring to FIGS. 2 and 7, the classifying unit 201 analyzes an execution code in operation 701 and determines whether each part of the execution code can be subject to software pipelining in operation 702.

If a part of the execution code can be subject to software pipelining, the mapping unit 202 maps the corresponding part to the CGA sp mode in operation 703.

On the other hand, if a part of the execution code cannot be subject to software pipelining, the classifying unit 202 detects the corresponding part as a target area in operation 704, and compares a VLIW schedule length of the target area with its CGA schedule length in operation 705.

If the CGA schedule length of the target area is shorter than its VLIW schedule length, the mapping unit 202 maps the target area to the CGA non-sp mode in operation 706. Conversely, if the CGA schedule length of the target area is equal to or longer than its VLIW schedule length, the mapping unit 202 maps the target area to the VLIW mode in operation 707.

According to the above description, since parts that cannot be subject to software pipelining can be executed in the CGA mode under a predetermined condition, higher operating speeds can be achieved by executing parts having high data parallelism in the CGA mode. Also, since unnecessary mode conversion can be prevented by using additional instructions, an overhead can be reduced and operation efficiency also can be enhanced.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor comprising a processor configured to execute code including a first part that is able to be subject to software pipelining in the code, and a second part that is disable to be subject to software pipelining in the code, the second part including a data part and a control part,
wherein the processor is configured: (i) to execute the first part, and the data part of the second part in a first execution mode, and (ii) to execute the control part of the second part in a second execution mode, and
when the first part and the data part, the data part and the first part, or different data parts are successively executed, the processor processes the code in the first execution mode without entering the second execution mode.

2. The reconfigurable processor of claim 1, wherein the first execution mode is based on a Coarse-Grained Array (CGA) architecture, and the second execution mode is based on Very a Long Instruction Word (VLIW) architecture.

3. A code conversion apparatus of a reconfigurable processor, comprising:
a classifying unit configured to classify a code into a first part that is able to be subject to software pipelining, and a second part that is disable to be subject to software pipelining, and to classify the second part into a data part and a control part;
a mapping unit configured to map the first part and the data part of the second part to a first execution mode of the reconfigurable processor, and the control part of the second part to a second execution mode of the reconfigurable processor; and
a mode conversion controller configured to insert, when the first part and the data part, the data part and the first part, or different data parts are successively executed, an additional instruction instructing continuous execution of the first execution mode without entering the second execution mode, into the code.

4. The code conversion apparatus of claim 3, wherein the first execution mode is based on a Coarse-Grained Array (CGA) architecture, and the second execution mode is based on a Very Long Instruction Word (VLIW) architecture.

5. The code conversion apparatus of claim 3, wherein the mode conversion controller inserts an instruction for prohibiting conversion of an execution mode between a point at which the data part ends in the code and a point at which the first part starts in the code, or between a point at which the first part ends in the code and a point at which the data part starts in the code, until a predetermined condition is satisfied.

6. The code conversion apparatus of claim 5, wherein the predetermined condition comprises a return instruction instructing returning to the second execution mode.

7. The code conversion apparatus of claim 3, wherein the mode conversion controller inserts a predetermined divergence instruction when different data parts are successively executed.

8. The code conversion apparatus of claim 3, wherein the classifying unit classifies the second part into the data part and the control part according to a schedule length.

9. The code conversion apparatus of claim 4, wherein the mapping unit inserts a predetermined CGA call instruction at a point at which the data part starts in the code.

10. A code conversion apparatus for a reconfigurable processor, comprising:
a classifying unit configured to classify a code into a SP part defined as a part that is able to be subject to software pipelining, a D part defined as a data part that is disable to be subject to software pipelining, and a C part defined as a control part that is disable to be subject to software pipelining;
a mapping unit configured to map the SP part and the D part to a Coarse-Grained Array (CGA) mode, and the C part to a Very Long Instruction Word (VLIW) mode; and
a mode conversion controller configured to insert, when the SP part and the D part, the D part and the SP part, or different D parts are successively executed, at least one additional instruction instructing continuous execution of the CGA mode without entering the VLIW mode, into the code.

11. The code conversion apparatus of claim 10, wherein the additional instruction includes a mode conversion prohibition instruction instructing continuous execution of the CGA mode until a VLIW return instruction is executed.

12. The code conversion apparatus of claim 11, wherein the additional instruction includes a divergence instruction that is inserted before an execution location of the VLIW return instruction.

13. A code conversion method for a reconfigurable processor, comprising:
classifying a code into a SP part defined as a part that is able to be subject to software pipelining, a D part defined as a data part that is disable to be subject to software pipelining, and a C part defined as a control part that is disable to be subject to software pipelining;
mapping the SP part and the D part to a Coarse-Grained Array (CGA) mode, and the C part to a Very Long Instruction Word (VLIW) mode; and
inserting, when the SP part and the D part, the D part and the SP part, or different D parts are successively executed, an additional instruction instructing continuous execution of the CGA mode without entering the VLIW mode, into the code.

14. The code conversion method of claim 13, wherein the additional instruction includes a mode conversion prohibition instruction instructing continuous execution of the CGA mode until a VLIW return instruction is executed.

15. The code conversion method of claim 13, wherein the additional instruction includes a divergence instruction that is inserted before an execution location of the VLIW return instruction.

16. A code conversion method of a reconfigurable processor, comprising:
classifying a code into a first part that is able to be subject to software pipelining, and a second part that is disable to be subject to software pipelining, and to classify the second part into a data part and a control part;
mapping the first part and the data part of the second part to a first execution mode of the reconfigurable processor, and the control part of the second part to a second execution mode of the reconfigurable processor; and
inserting, when the first part and the data part, the data part and the first part, or different data parts are successively executed, an additional instruction instructing continuous execution of the first execution mode without entering the second execution mode, into the code.

17. The code conversion method of claim 16, wherein the first execution mode is based on a Coarse-Grained Array (CGA) architecture, and the second execution mode is based on a Very Long Instruction Word (VLIW) architecture.

18. The code conversion method of claim 16, wherein the inserting comprises inserting an instruction for prohibiting conversion of an execution mode between a point at which the data part ends in the code and a point at which the first part starts in the code, or between a point at which the first part ends in the code and a point at which the data part starts in the code, until a predetermined condition is satisfied.

19. The code conversion method of claim 18, wherein the predetermined condition comprises a return instruction instructing returning to the second execution mode.

20. The code conversion method of claim 16, wherein the inserting comprises inserting a predetermined divergence instruction when different data parts are successively executed.

21. The code conversion method of claim 16, wherein the classifying comprises classifying the second part into the data part and the control part according to a schedule length.

22. The code conversion method of claim 17, wherein the mapping comprises inserting a predetermined CGA call instruction at a point at which the data part starts in the code.
